(19) United States
(12) Patent Application Publication
(10) Pub. No.: US 2024/0259064 A1
(43) Pub. Date: Aug. 1, 2024

(54) METHOD AND APPARATUS OF BEAM MANAGEMENT FOR CHANGING TRANSMISSION POWER

(71) Applicant: KT CORPORATION, Gyeonggi-do (KR)

(72) Inventor: KI-HYEON PARK, Gyeonggi-do (KR)

(73) Assignee: KT CORPORATION, Gyeonggi-do (KR)

(21) Appl. No.: 18/428,241

(22) Filed: Jan. 31, 2024

(30) Foreign Application Priority Data
Jan. 31, 2023 (KR) 10-2023-0012841
Dec. 6, 2023 (KR) 10-2023-0175378

(51) Int. Cl. H04B 7/06; H04W 76/20

(52) U.S. Cl. CPC H04B 7/0626; H04B 7/06968; H04W 76/20

(57) ABSTRACT

Provided are a method and apparatus for configuring and managing beam resources to control transmission power for network power reduction. The method may include receiving configuration information for a plurality of channel state information-reference signals (CSI-RS) and obtaining a transmission power change for a downlink signal, based on the received configuration information. A transmission power offset may be configured for each of the plurality of CSI-RSs.

### CROSS-REFERENCE TO RELATED THE APPLICATION

This application is based on and claims priority under 35 U.S.C. § 119 to Patent Applications No. 10-2023-0012841 filed on Jan. 31, 2023 and No. 10-2023-0175378 filed on Dec. 6, 2023 in the Korean Intellectual Property Office, the disclosures of which are incorporated by reference herein in their entirety.

### BACKGROUND

### Technical Field

The disclosure relates to a 5^{th} generation new radio (5G NR) system based on a 3^{rd} generation partnership project.

### Description of the Related Art

With the increase in the number of communication devices, there is a consequent rise in communication traffic that needs to be managed. To handle this increased communication traffic, a next generation 5G system, which is an enhanced mobile broadband communication system compared to the exiting LTE system, has become necessary. Such a next generation 5G system has been developed based on scenarios which are classified into Enhanced Mobile BroadBand (eMBB), Ultra-reliability and low-latency communication (URLLC), Massive Machine-Type Communications (mMTC), and the like.

eMBB, URLLC, and mMTC are represent next generation mobile communication scenarios. eMBB is characterized by high spectrum efficiency, high user experienced data rate, high peak data rate. URLLC is characterized by ultra-reliable, ultra-low latency, and ultra-high availability (e.g., vehicle-to-everything (V2X), Emergency Service, Remote Control). mMTC is characterized low cost, low energy, short packet, and massive connectivity (e.g., Internet of Things (IoT)).

### SUMMARY

An aspect of the disclosure is to provide a method of configuring and managing beam resources in a wireless communication system. In particular, an aspect of the disclosure is to provide a method of configuring and managing beam resources to control transmission power for network power reduction.

According to an embodiment of the disclosure, a UE in a wireless communication system receives configuration information for a plurality of channel state information-reference signals (CSI-RS) from a base station and obtains transmission power change for a downlink signal, based on the received configuration information for the plurality of CSI-RSs received from the base station. A transmission power offset may be configured for each of the plurality of CSI-RSs.

Further, according to an embodiment of the disclosure, a base station in a wireless communication system determines a transmission power change for a downlink signal and transmits configuration information for a plurality of channel state information-reference signals (CSI-RS) to a UE after determining the transmission power change. A transmission power offset may be configured for each of the plurality of CSI-RSs.

Further, according to an embodiment of the disclosure, a communication apparatus in a wireless communication system includes at least one processor, and at least one memory configured to store instructions and be operably electrically connectable to the at least one processor. The at least one processor is configured to execute the instructions stored in the at least one memory to perform operations of: receiving configuration information for a plurality of channel state information-reference signals (CSI-RS) from a base station and obtaining a transmission power change for a downlink signal based on the configuration information for the plurality of CSI-RSs received from the base station. The communication apparatus may configure a transmission power offset for each of the plurality of CSI-RSs.

Further, according to an embodiment of the disclosure, a communication apparatus in a wireless communication system includes at least one processor, and at least one memory configured to store instructions and be operably electrically connectable to the at least one processor. The at least one processor is configured to execute the instructions stored in the at least one memory to perform operations of: determining a transmission power change for a downlink signal and transmitting configuration information for a plurality of channel state information-reference signals (CSI-RS) to a UE after determining the transmission power change. for the communication apparatus may configure a transmission power offset for each of the plurality of CSI-RSs is provided

The configuration information for the plurality of CSI-RSs may be single CSI-RS resource configuration information, and a quasi co-location (QCL) relationship may be configured for each of the plurality of CSI-RSs.

Each of the plurality of CSI-RSs may be linked to an identity (ID) associated with a corresponding CSI-RS resource, and the transmission power offset may be configured based on the ID.

Meanwhile, the UE (or the communication apparatus) may receive at least one CSI-RS from the base station and perform CSI feedback based on the at least one received CSI-RS. The base station may transmit the at least one CSI-RS to the UE and receive CSI feedback from the UE.

The information for the plurality of CSI-RSs may be transmitted from the base station to the UE through a radio resource control (RRC) message, and the UE may receive this information.

### BRIEF DESCRIPTION OF THE DRAWINGS

FIG. 1 is a diagram illustrating a wireless communication system.

FIG. 2 is a diagram illustrating a structure of a radio frame used in new radio (NR).

FIGS. 3A to 3C illustrate exemplary architectures for a wireless communication service.

FIG. 4 illustrates a slot structure of a NR frame.

FIG. 5 shows an example of a subframe type in NR.

FIG. 6 illustrates a structure of a self-contained slot.

FIGS. 7A to 7C illustrate the structure of a synchronization signal block (SSB) in NR.

FIG. 8 illustrates SSB transmission in NR.

FIG. 9 illustrates beam sweeping in NR.

FIG. 10 is a signal flowchart that illustrates a method of processing channel state information (CSI).

FIG. 11 is a diagram for illustrating a transmission power management scheme based on beams according to an embodiment of the disclosure.

FIG. 12 is a flowchart for an operation method of a UE according to an embodiment of the disclosure.

FIG. 13 is a flowchart for an operation method of a base station according to an embodiment of the disclosure.

FIG. 14 is a block diagram illustrating apparatuses according to an embodiment of the disclosure.

FIG. 15 is a block diagram showing a UE according to an embodiment of the disclosure.

FIG. 16 is a block diagram of a processor.

FIG. 17 is a detailed block diagram of a transceiver of a first apparatus shown in FIG. 14 or a transceiving unit of an apparatus shown in FIG. 15.

### DETAILED DESCRIPTION

The technical terms used in this document are for merely describing specific embodiments and should not be considered limiting the embodiments of disclosure. Unless defined otherwise, the technical terms used in this document should be interpreted as commonly understood by those skilled in the art but not too broadly or too narrowly. If any technical terms used here do not precisely convey the intended meaning of the disclosure, they should be replaced with or interpreted as technical terms that accurately understood by those skilled in the art. The general terms used in this document should be interpreted according to their dictionary definitions, without overly narrow interpretations.

The singular form used in the disclosure includes the plural unless the context dictates otherwise. The term ‘include’ or ‘have’ may represent the presence of features, numbers, steps, operations, components, parts or the combination thereof described in the disclosure. The term ‘include’ or ‘have” may not exclude the presence or addition of another feature, another number, another step, another operation, another component, another part or the combination thereof.

The terms ‘first’ and ‘second’ are used to describe various components without limiting them to these specific terms. The terms ‘first’ and ‘second’ are only used to distinguish one component from another component. For example, a first component may be named as a second component without departing from the scope of the disclosure.

When an element or layer is referred to as being “connected to” or “coupled to” another element or layer, it may be directly connected or coupled to the other element or layer, there might be intervening elements or layers. In contrast, when an element or layer is referred to as being “directly connected to” or “directly coupled to” another element or layer, there are no intervening elements or layers.

Hereinafter, the exemplary embodiments of the disclosure will be described in detail with reference to the accompanying drawings. In describing the disclosure, for ease of understanding, the same reference numerals will be used throughout the drawings for the same components, and repetitive description on these components will be omitted. Detailed description on well-known arts that may obscure the essence of the disclosure will be omitted. The accompanying drawings are provided to merely facilitate understanding of the embodiment of disclosure and should not be seen as limiting. It should be recognized that the essence of this disclosure extends beyond the illustrations, encompassing, replacements or equivalents in variations of what is shown in the drawings.

In this disclosure, “A or B” may mean “only A”, “only B”, or “both A and B”. In other words, “A or B” in the disclosure may be interpreted as “A and/or B”. For example, “A, B or C” may mean “only A”, “only B”, “only C”, or “any combination of A, B and C”.

In this disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In this disclosure, “at least one of A and B” may mean “only A”, “only B” or “both A and B”. In addition, “at least one of A or B” or “at least one of A and/or B” may be interpreted as the same as “at least one of A and B”.

In addition, “at least one of A, B and C” may mean “only A”, “only B”, “only C”, or “any combination of A, B and C”. Further, “at least one of A, B or C” or “at least one of A, B and/or C” may mean “at least one of A, B and C”.

Also, parentheses used in this disclosure may mean “for example”. For example, “control information (PDCCH)” may mean that “PDCCH” is an example of “control information”. However, “control information” in this disclosure is not limited to “PDCCH”. As another example, “control information (i.e., PDCCH)” may also mean that “PDCCH” is an example of “control information”.

Each of the technical features described in one drawing in this disclosure may be implemented independently or simultaneously.

In the accompanying drawings, user equipment (UE) is illustrated as an example and may be referred to as a terminal, mobile equipment (ME), and the like. UE may be a portable device such as a laptop computer, a mobile phone, a personal digital assistance (PDA), a smart phone, a multimedia device, or the like. UE may be a non-portable device such as a personal computer (PC) or a vehicle-mounted device.

Hereinafter, the UE may be as an example of a device capable of wireless communication. The UE may be referred to as a wireless communication device, a wireless device, or a wireless apparatus. The operation performed by the UE may be applicable to any device capable of wireless communication. A device capable of wireless communication may also be referred to as a radio communication device, a wireless device, or a wireless apparatus.

A base station generally refers to a fixed station that communicates with a wireless device. The base station may include an evolved-NodeB (eNodeB), an evolved-NodeB (eNB), a BTS (Base Transceiver System), an access point (Access Point), gNB (Next generation NodeB), RRH (remote radio head), TP (transmission point), RP (reception point), and the repeater (relay).

While embodiments of the disclosure are described based on an long term evolution (LTE) system, an LTE-advanced (LTE-A) system, and an new radio (NR) system, such embodiments may be applicable to any communication system that fits the described criteria.

### <Wireless Communication System>

With the success of long-term evolution (LTE)/LTE-A (LTE-Advanced) for the 4^{th} generation mobile communication, the next generation mobile communication (e.g., 5^{th} generation: also known as 5G mobile communication) has been commercialized, and the follow-up studies are also ongoing.

The 5^{th} generation mobile communications, as defined by the International Telecommunication Union (ITU), provide a data transmission rate of up to 20 Gbps and a minimum actual transmission rate of at least 100 Mbps anywhere. The official name of the 5^{th} generation mobile telecommunications is ‘IMT-2020.’

ITU proposes three usage scenarios: enhanced Mobile Broadband (eMBB), massive Machine Type Communication (mMTC) and Ultra Reliable and Low Latency Communications (URLLC).

URLLC is a usage scenario requiring high reliability and low latency. For example, services such as automatic driving, factory automation, augmented reality require high reliability and low latency (e.g., a delay time of less than 1 ms). The delay time of current 4G (e.g., LTE) is statistically about 21 to 43 ms (best 10%) and about 33 to 75 ms (median), which is insufficient to support services requiring a delay time of about 1 ms or less. Meanwhile, eMBB is a usage scenario that requires mobile ultra-wideband.

That is, the 5G mobile communication system offers a higher capacity compared to current 4G LTE. The 5G mobile communication system may be designed to increase the density of mobile broadband users and support device to device (D2D), high stability, and machine type communication (MTC). 5G research and development focus on achieving lower latency times and lower battery consumption compared to 4G mobile communication systems, enhancing the implementation of the Internet of things (IoTs). A new radio access technology, known as new RAT or NR, may be introduced for such 5G mobile communication.

An NR frequency band is defined to include two frequency ranges FR1 and FR2. Table 1 below shows an example of the two frequency ranges FR1 and FR2. However, the numerical values associated with each frequency range may be subject to change, and the embodiments are not limited thereto. For convenience of description, FR1 in the NR system may refer to a Sub-6 GHz range, and FR2 may refer to an above-6 GHz range, which may be called millimeter waves (mmWs).

TABLE 1

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHZ | 60, 120, 240 | kHz |

The numerical values of the frequency ranges may be subject to change in the NR system. For example, FR1 may range from about 410 MHz to 7125 MHz as listed in [Table 1]. That is, FR1 may include a frequency band of 6 GHZ (or 5850, 5900, and 5925 MHz) or higher. For example, the frequency band of 6 GHz (or 5850, 5900, and 5925 MHz) or higher may include an unlicensed band. The unlicensed band may be used for various purposes, for example, vehicle communication (e.g., autonomous driving).

The 3GPP communication standards define downlink (DL) physical channels and DL physical signals. DL physical channels are related to resource elements (REs) that convey information from higher layers while DL physical signals, used in the physical layer, correspond to REs that do not carry information from a higher layer. For example, DL physical channels include physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH). DL physical signals include reference signals (RSs) and synchronization signals (SSs). A reference signal (RS) is also known as a pilot signal and has a predefined special waveform known to both a gNode B (gNB) and a UE. For example, DL RSs include cell specific RS, UE-specific RS (UE-RS), positioning RS (PRS), and channel state information RS (CSI-RS). The 3GPP LTE/LTE-A standards also define uplink (UL) physical channels and UL physical signals. UL channels correspond to REs with information from a higher layer. UL physical signals are used in the physical layer and correspond to REs which do not carry information from a higher layer. For example, UL physical channel include physical uplink shared channel (PUSCH), physical uplink control channel (PUCCH), and physical random access channel (PRACH). UL physical signals include a demodulation reference signal (DMRS) for a UL control/data signal, and a sounding reference signal (SRS) used for UL channel measurement.

In this disclosure, PDCCH/PCFICH/PHICH/PDSCH refers to a set of time-frequency resources or a set of REs carrying downlink control information (DCI)/a control format indicator (CFI)/a DL acknowledgement/negative acknowledgement (ACK/NACK)/DL data. Further, PUCCH/PUSCH/PRACH refers to a set of time-frequency resources or a set of REs carrying UL control information (UCI)/UL data/a random access signal.

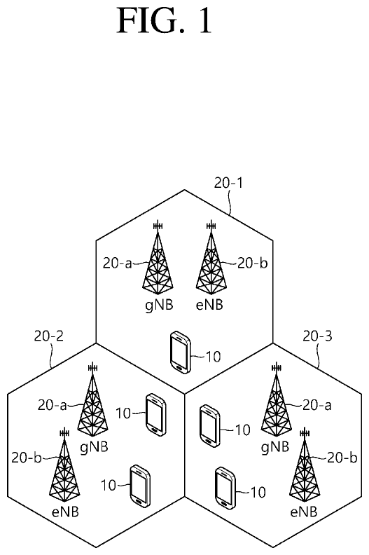

FIG. 1 is a diagram illustrating a wireless communication system.

Referring to FIG. 1, the wireless communication system may include at least one base station (BS). For example, the BSs may include a gNodeB (or gNB) 20a and an eNodeB (or eNB) 20b. The gNB 20a supports 5G mobile communication. The eNB 20b supports 4G mobile communication, that is, long term evolution (LTE).

Each BS 20a and 20b provides a communication service for a specific geographic area (commonly referred to as a cell) (20-1, 20-2, 20-3). The cell may also be divided into a plurality of areas (referred to as sectors).

A user equipment (UE) typically belongs to one cell, and the cell to which the UE belongs is called a serving cell. A base station providing a communication service to a serving cell is referred to as a serving base station (e.g., serving BS). Since the wireless communication system is a cellular system, there are other cells adjacent to the serving cell. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station 20 to the UE 10, and uplink means communication from the UE 10 to the base station 20. In the downlink, a transmitter may be a part of the base station 20, and a receiver may be a part of the UE 10. In the uplink, the transmitter may be a part of the UE 10, and the receiver may be a part of the base station 20.

In a wireless communication system, there are primarily two schemes: frequency division duplex (FDD) scheme and time division duplex (TDD) scheme. In the FDD scheme, uplink transmission and downlink transmission occur on different frequency bands. Conversely, the TDD scheme allows both uplink transmission and downlink transmission to use the same frequency band, but at different times. A key characteristic of the TDD scheme is the substantial reciprocity of the channel response, meaning that the downlink channel response and the uplink channel response are almost identical within a given frequency domain. This reciprocity in TDD-based radio communication systems enables the estimation of the downlink channel response from the uplink channel response. In the TDD scheme, since uplink transmission and downlink transmission are time-divided in the entire frequency band, it is not possible to simultaneously perform downlink transmission by the base station and uplink transmission by the UE. In a TDD system where uplink transmission and downlink transmission are divided into subframe units, uplink transmission and downlink transmission are performed in different subframes.

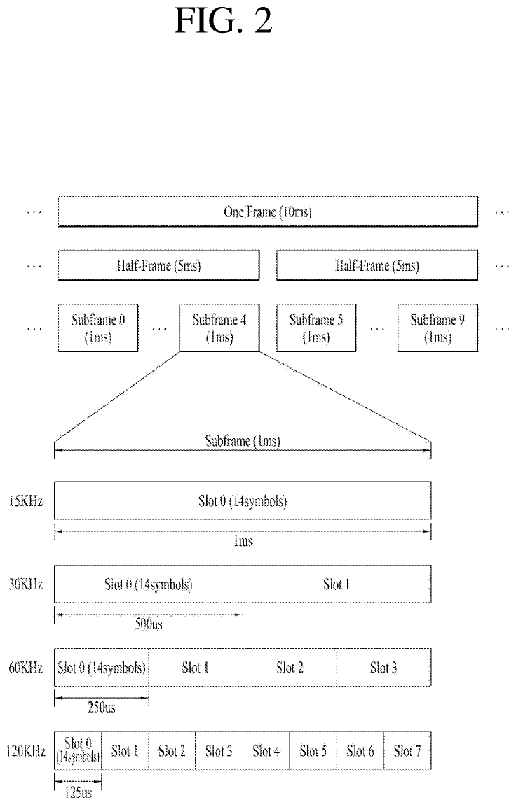

FIG. 2 is a diagram illustrating a structure of a radio frame used in NR.

In NR, UL and DL transmissions are configured in frames. Each radio frame has a length of 10 ms and is divided into two 5-ms half frames (HFs). Each half frame is divided into five 1-ms subframes. A subframe is divided into one or more slots, and the number of slots in a subframe depends on the subcarrier spacing (SCS). Each slot includes 12 or 14 OFDM(A) symbols according to a Cyclic Prefix (CP). With a normal CP, a slot includes 14 OFDM symbols. With an extended CP, a slot includes 12 OFDM symbols. A symbol may include an OFDM symbol (CP-OFDM symbol) and an SC-FDMA symbol (or DFT-s-OFDM symbol).

### <Support of Various Numerologies>

As wireless communication technology advances, the NR system may offer various numerologies to UEs. For example, when a subcarrier spacing (SCS) is set at 15 kHz, it supports a broad range of the typical cellular bands. When a subcarrier spacing (SCS) is set at 30 kHz/60 kHz, it supports a dense-urban, lower latency, wider carrier bandwidth. When the SCS is set at 60 kHz or higher, it supports a bandwidth greater than 24.25 GHz in order to overcome phase noise.

These numerologies may be defined by the cyclic prefix (CP) length and the SCS. A single cell in the NR system is capable of proving multiple numerologies to UEs. Table 2 below shows the relationship between the subcarrier spacing, corresponding CP length, and the index of a numerology (represented by u).

TABLE 2

| | Δf = | |
|---|---|---|
| M | 2^{μ} · 15 [kHz] | CP |
| 0 | 15 | normal |
| 1 | 30 | normal |
| 2 | 60 | normal, |
| | | extended |
| 3 | 120 | normal |
| 4 | 240 | normal |
| 5 | 480 | normal |
| 6 | 960 | normal |

Table 3 below shows the number of OLDM symbols per slot (N^{slot}_{symb}), the number of slots per frame (N^{frame,μ}ₛₗₒₜ), and the number of slots per subframe (N^{subframe,μ}ₛₗₒₜ) according to each numerology expressed by u in the case of a normal CP.

TABLE 3

| | Δf = | | | |
|---|---|---|---|---|
| μ | 2^{μ} · 15 [kHz] | N^{slot}_{symb} | N^{frame, μ}ₛₗₒₜ | N^{subframe, u}ₛₗₒₜ |
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

Table 4 below shows the number of OLDM symbols per slot (N^{slot}_{symb}), the number of slots per frame (N^{frame,μ}ₛₗₒₜ), and the number of slots per subframe (N^{subframe,μ}ₛₗₒₜ) of a numerology represented by u in the case of an extended CP.

TABLE 4

| μ | SCS (15*2^{μ}) | N^{slot}_{symb} | N^{frame, μ}ₛₗₒₜ | N^{subframe, u}ₛₗₒₜ |
|---|---|---|---|---|
| 2 | 60 KHz (u = 2) | 12 | 40 | 4 |

In the NR system, OFDM(A) numerologies (e.g., SCS, CP length, and so on) may be configured differently across multiple cells that are integrated with a single UE. Accordingly, the duration of a time resource may vary among these integrated cells. Here, the duration may be referred to as a section. The time resource may include a subframe, a slot, or a transmission time interval (TTI). Further, the time resource may be collectively referred to as a time unit (TU) for simplicity and include the same number of symbols.

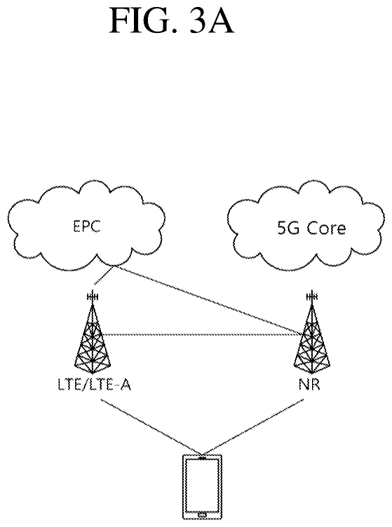

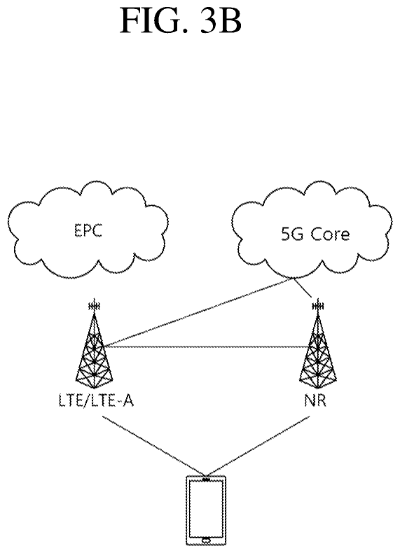

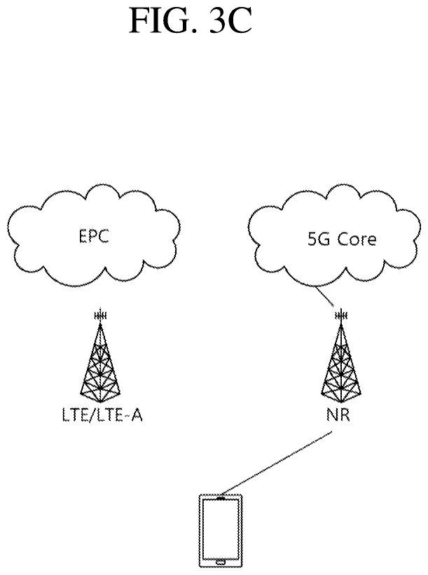

FIGS. 3A to 3C illustrate exemplary architectures for a wireless communication service.

Referring to FIG. 3A, a UE is connected in dual connectivity (DC) with an LTE/LTE-A cell and a NR cell.

The NR cell is connected with a core network for the legacy fourth-generation mobile communication, that is, Evolved Packet core (EPC).

Referring to FIG. 3B, the LTE/LTE-A cell is connected with a core network for 5^{th} generation mobile communication, that is, a 5G core network.

A service provided by the architecture shown in FIGS. 3A and 3B is referred to as a non-standalone (NSA) service.

Referring to FIG. 3C, a UE is connected only with an NR cell. A service provided by this architecture is referred to as a standalone (SA) service.

In the new radio access technology (NR), the use of a downlink subframe for reception from a base station and an uplink subframe for transmission to the base station may be employed. This method may be applicable to both paired and unpaired spectrums. Paired spectrums involve two subcarriers designated for downlink and uplink operations. For example, one subcarrier within a pair of spectrums may include a pair of a downlink band and an uplink band.

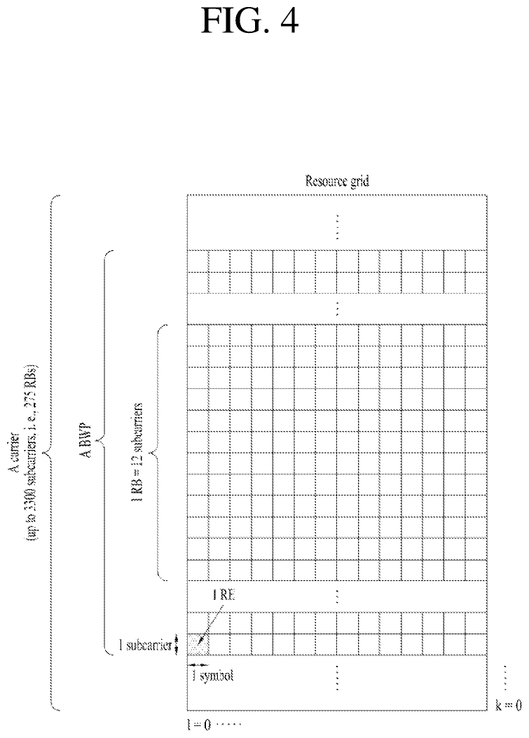

FIG. 4 illustrates a slot structure of an NR frame.

A slot in the NR system includes a plurality of symbols in the time domain. For example, in the case of the normal CP, one slot includes seven symbols. On the other hand, in the case of the extended CP, one slot includes six symbols. A carrier includes a plurality of subcarriers in the frequency domain. A resource block (RB) is defined as a set of consecutive subcarriers (e.g., 12 consecutive subcarriers) in the frequency domain. A bandwidth part (BWP) is defined as a sequence of consecutive physical resource blocks (PRBs) in the frequency domain and may be associated with a specific numerology (e.g., SCS, CP length, etc.). A UE may be configured with up to N (e.g., five) BWPs in each of downlink and uplink. Downlink or uplink transmission is performed through an activated BWP. Among the BWPs configured for the UE, only one BWP may be activated at a given time. In the resource grid, each element is referred to as a resource element (RE), and one complex symbol may be mapped thereto.

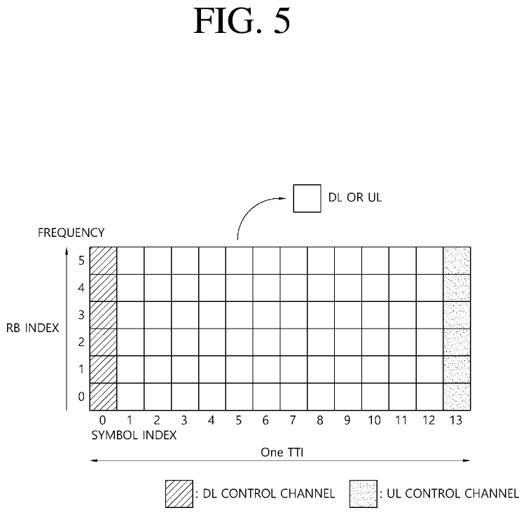

FIG. 5 shows an example of a subframe type in NR.

In NR (or new RAT), a Transmission Time Interval (TTI), as shown in FIG. 5, may be referred to as a subframe or slot. The subframe (or slot) may be utilized in in the NR TDD system to minimize data transmission delay. As shown in FIG. 5, a subframe (or slot) includes 14 symbols. The symbol at the head of the subframe (or slot) may be allocated for a DL control channel, and the symbol at the end of the subframe (or slot) may be assigned for a UL control channel. The remaining symbols may be used for either DL data transmission or UL data transmission. This subframe (or slot) structure allows sequential downlink and uplink transmissions in one single subframe (or slot). Accordingly, downlink data may be received in a subframe (or slot) and uplink ACK/NACL may be transmitted in the same subframe (or slot).

Such a subframe (or slot) structure may be referred to as a self-contained subframe (or slot).

The first N symbols in a slot may be used to transmit a DL control channel and referred to as a DL control region, hereinafter. The last M symbols in the slot may be used to transmit a UL control channel and referred to as a UL control region. N and M are integers greater than 0. A resource area between the DL control region and the UL control region may be used for either DL data transmission or UL data transmission and referred to as a data region. For example, a physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region.

Using this subframe (or slot) structure reduces the time required for retransmitting data that has failed in reception, thereby minimizing overall data transmission latency. In such a self-contained subframe (or slot) structure, a time gap may be required for transitioning between a transmission mode and a reception mode or from the reception mode to the transmission mode. To accommodate this, a few OFDM symbols when switch from DL to UL in the subframe structure may be configured to a guard period (GP).

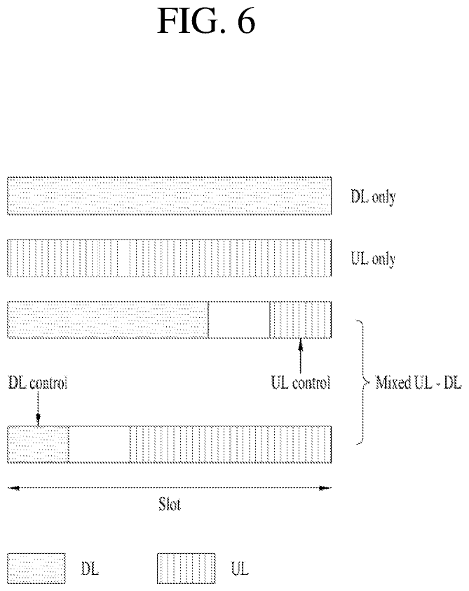

FIG. 6 illustrates a structure of a self-contained slot.

In the NR system, the frames are structured as a self-contained structure, where one single slot includes a DL control channel, either a DL or UL data channel, and UL control channel. For example, the first N symbols in a slot may be used for transmitting a DL control channel and referred to as a DL control region. The last M symbols in the slot may be used for transmitting an UL control channel and referred to as a UL control region. N and M are integers greater than 0. A resource area between the DL control region and the UL control region may be used for either DL data transmission or UL data transmission and referred to as a data region.

For example, the following configurations may be taken into account. The durations are listed in temporal order.
1. DL only configuration
2. UL only configuration
3. Mixed UL-DL configuration
   DL region+Guard Period (GP)+UL control region
   DL control region+GP+UL region
DL region: (i) DL data region, (ii) DL control region+DL data region
UL region: (i) UL data region, (ii) UL data region+UL control region

A PDCCH may be transmitted in the DL control region, and a PDSCH may be transmitted in the DL data region. A PUCCH may be transmitted in the UL control region, and a PUSCH may be transmitted in the UL data region. Through the PDCCH, Downlink Control Information (DCI), for example, DL data scheduling information or UL data scheduling data may be transmitted. Through the PUCCH, Uplink Control Information (UCI), for example, ACK/NACK (Positive Acknowledgement/Negative Acknowledgement) information with respect to DL data, Channel State Information (CSI) information, or Scheduling Request (SR) may be transmitted. A guard period (GP) provides a time gap for a gNB and a UE to switch between the transmission and reception modes. Part of symbols within a subframe that correspond to the transition from DL to UL may be configured as the GP.

### <CSI-RS>

A CSI-RS is a channel state information reference signal. The CSI-RS is a reference signal used for the UE to report CSI feedback to an associated serving cell.

The CSI-RS may be composed of one or more CSI-RS configurations, including a zero-power CSI-RS and a non-zero-power CSI-RS.

For the non-zero-power CSI-RS, the sequence is generated according to clause 7.4.1.5.2 of 3GPP TS 38.211 and mapped onto resource elements according to clause 7.4.1.5.3.

In the case of the zero-power CSI-RS, the UE assumes that the resource elements defined in clause 7.4.1.5.3 of 3GPP TS 38.211 are not used for PDSCH transmission and therefore does not estimate downlink transmission on the resource elements.
CSI-RS locations in a slot
1) Frequency location: The starting subcarrier of a component RE pattern is as follows.
For 1 port CSI-RS, no limitation.
For Y=2, limited to one of even number of subcarriers.
For Y=4, limited to one of subcarrier 0, 4, and 8.
where, Y is the gap of the starting subcarrier.
2) Time location: transmitted from 5, 6, 7, 8, 9, 10, 12, and 13 OFDM symbols.
Cycle

The following CSI-RS transmission cycle is supported in NR.
{5, 10, 20, 40, 80, 160, 320, 640} slots

### <Synchronization Signal Block (SSB) in NR>

In 5G NR, a synchronization signal/physical broadcast channel block (SS/PBCH Block: SSB) includes information for a UE's an initial access. For example, the information includes a physical broadcast channel (PBCH) with a master information block (MIB) and a synchronization signal (SS) encompassing primary synchronization signal (PSS) and a secondary synchronization signal (SSS).

In addition, a plurality of SSB may be grouped to form an SS burst, and multiple SS bursts may be grouped to create an SS burst set. Each SSB is typically beamformed in a specific direction, allowing various SS blocks within the SS burst set to accommodate UEs located in different directions.

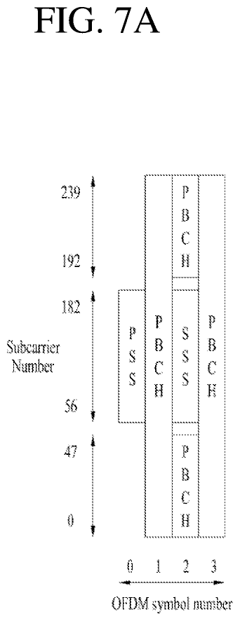

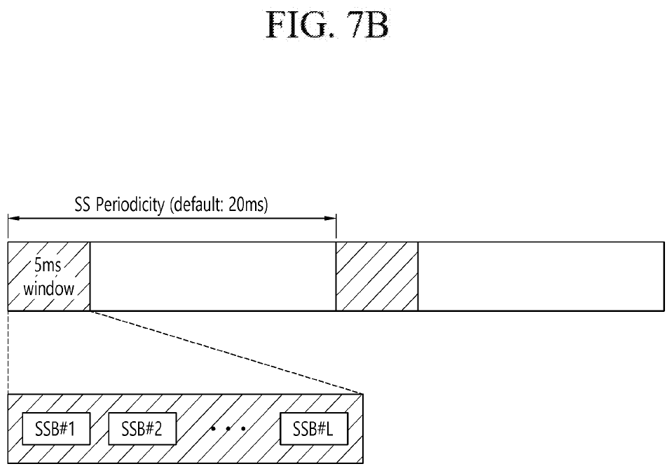

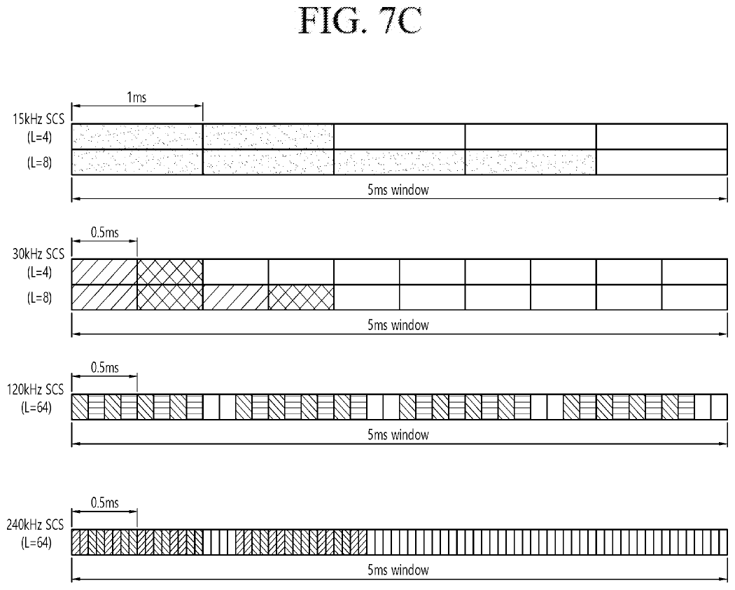

FIGS. 7A to 7C illustrate the structure of a synchronization signal block (SSB) in NR.

A UE may utilize an SSB for various tasks such as cell search, system information acquisition, beam alignment for initial access, and DL measurement. The term SSB may be used interchangeably with synchronization signal/physical broadcast channel (SS/PBCH).

Referring to FIG. 7A, the SSB includes a primary synchronization signal (PSS), a secondary synchronization signal (SSS), and a physical broadcast channel (PBCH). The SSB is configured in four consecutive orthogonal frequency division multiplexing (OFDM) symbols, and the PSS, the PBCH, the SSS/PBCH and the PBCH are transmitted in the respective OFDM symbols. Each of the PSS and the SSS includes one OFDM symbol and 127 subcarriers, and the PBCH includes three OFDM symbols and 576 subcarriers. The PBCH employs polar coding and quadrature phase shift keying (QPSK). The PBCH includes both data REs and demodulation reference signal (DMRS) REs in each OFDM symbol. There are three DMRS REs per RB, with three data REs interspersed between every two adjacent DMRS REs.

Referring to FIGS. 7B and 7C, an SSB in an SS burst may be transmitted within a 5 ms window regardless of the cycle of the SS burst set. The candidate number of SSBs that can fit in the 5 ms window may be L.

For various frequency bands, the maximum number L of SSBs in the SS burst set may vary as per the following examples (it is assumed that the minimum number of SSBs in each SS burst set is 1, to define performance requirement).
frequency band less than 3 GHz: L=4
frequency band of 3 GHz to 6 GHZ: L=8
frequency band of 6 GHz to 52.6 GHz: L=64

As shown in FIG. 7B, an SSB cycle may be 20 ms. Specifically, a default value for initial cell selection may be 20 ms. In addition, the SSB cycle in RRC CONNECTED/RRC IDLE and NSA may for example be one of {5,10,20,40,80,160} ms.

FIG. 7C shows the SSB configuration within a 5 ms window. FIG. 7C shows the examples of SSB according to L in subcarrier spacing (SCS) and each SCS. Referring to FIG. 7C, two SSBs may be placed in each patterned area. For example, when L=4 in 15 kHz SCS, two SSBs are positioned in each of two patterned areas. Accordingly, a total of 4 SSBs may be transmitted within the 5 ms window. As another example, when L=64 in 240 KHZ SCS, SSBs are respectively placed in 32 patterned areas. Accordingly, a total of 64 SSBs may be transmitted within the 5 ms window.

In the time domain of the time-frequency structure of an SS/PBCH block, the SSB may be composed of 4 OFDM symbols, and the 4 OFDM symbols may be numbered from 0 to 3 in ascending order in the SSB. In the SSB, PSS, SSS and PBCH (related to DM-RS) may use OFDM symbols.

In the frequency domain, the SSB may include 240 consecutive subcarriers. Here, the subcarriers may be numbered from 0 to 239 in the SSB. Here, K represents a frequency index, 1 is a time index, and k and l may be defined within one SSB.

The UE may consider SSBs transmitted with the same block index as quasi co-located (QCL) in terms of r Doppler spread, Doppler shift, average gain, average delay, and spatial Rx parameters. However, the UE may not regard SSBs transmitted with different block indices as being QLC.

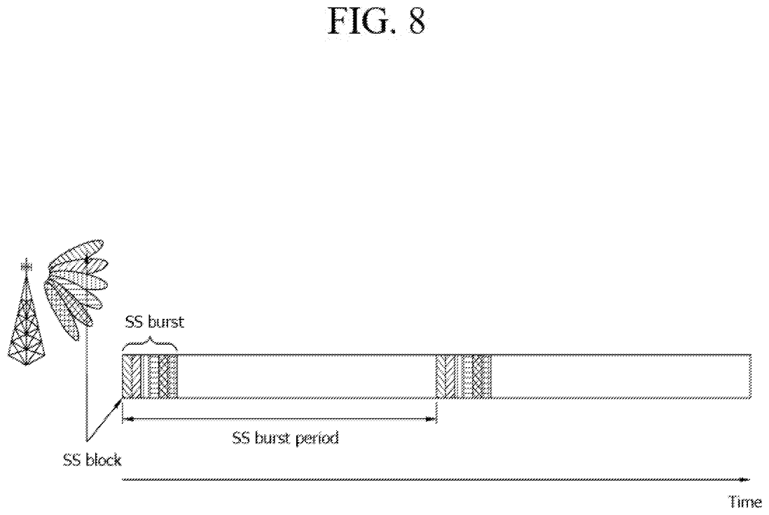

FIG. 8 illustrates SSB transmission in NR.

Referring to FIG. 8, an SS burst is transmitted in at regular intervals. Accordingly, a UE receives SSBs and conduct cell detection and measurement.

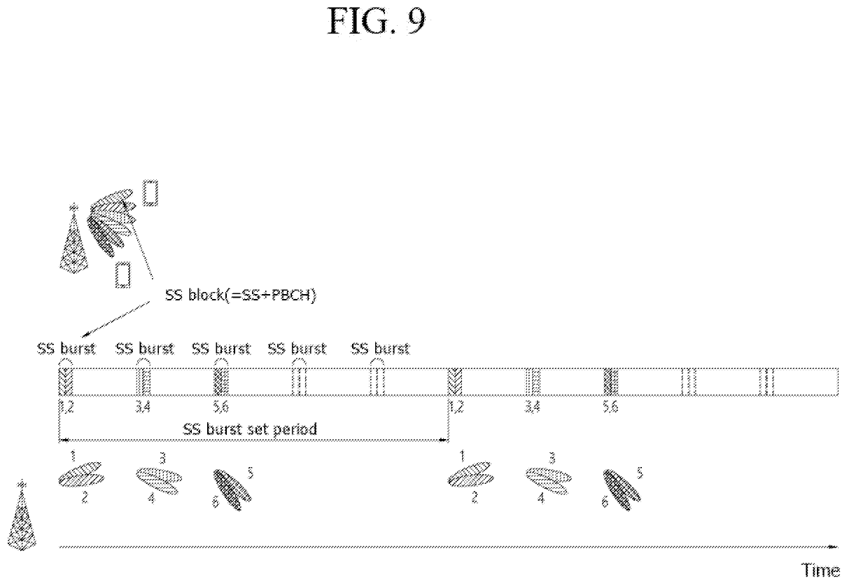

Meanwhile, in 5G NR, beam sweeping is performed on the SSB. Such beam sweeping will be described with reference to FIG. 9.

FIG. 9 illustrates beam sweeping in NR.

A base station transmits each SSB within an SS burst over time while performing beam sweeping. In this case, multiple SSBs in an SS burst set are transmitted to support UEs present in different directions. As shown in FIG. 9, the SS burst set includes one to six SSBs, and each SS burst includes two SSBs.

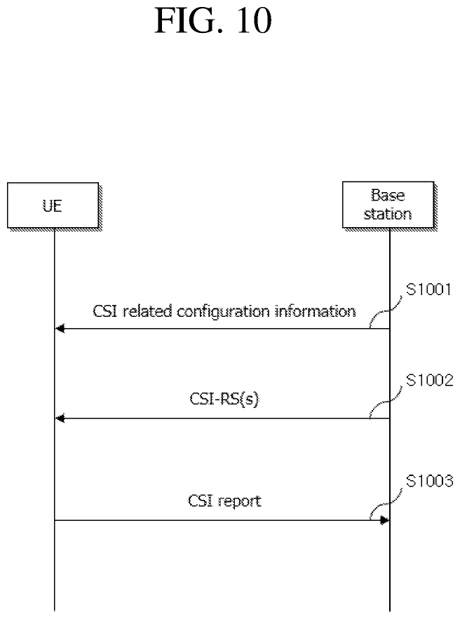

FIG. 10 illustrates channel state information (CSI) related procedure.

In 5G NR, the CSI-RS is used for performing operations, such as time/frequency tracking, CSI calculation, layer 1 (L1)-reference signal received power (RSRP) and L1-signal to interference and noise ratio (SINR) computation, and mobility. Here, the CSI calculation may be related to CSI acquisition, and L1-RSRP and L1-SINR computation may be related to beam management (BM).

Referring to FIG. 10, to perform at least one of the foregoing operations using the CSI-RS, the UE receives the CSI-related configuration information from the base station through radio resource control (RRC) signaling (S1001).

The CSI-related configuration information may include at least one of CSI-interference management (IM) resource-related information, CSI measurement configuration-related information, CSI resource configuration-related information, CSI-RS resource-related information, and CSI report configuration-related information.

When receiving at least one CSI-RS (i.e., one CSI-RS or multiple CSI-RSs) from the base station (S1002), the UE performs the CSI calculation based on the CSI-related configuration information to acquire the CSI, and then performs CSI feedback, i.e., transmits a CSI report to the base station (S1003).

In 3GPP NR, beam resources are typically provided to the UE in a transparent form. The base station supplies the UE with the location of the resource region of the SSB or CSI-RS, each composed of a specific type of beam. The base station identified the relative quality of that beam for the UE based on the CSI feedback or similar information from the UE. This information is used to configure a beam for a specific UE based on the identified quality. This operation was generally configured/managed in the forms of common beam sweeping performed changing an SSB index and dedicated beam sweeping performed through the CSI-RS.

In NR Release 18, various studies have been conducted aimed at reducing network power consumption. It has been agreed to pursue specific standardization efforts based on the objectives outlined in the following Table 5.

TABLE 5
1. Specify SSB-less SCell operation for inter-band CA for
FR1 and co-located cells, if found feasible by RAN4 study,
where a UE measures SSB transmitted on PCell or another
SCell for an SCell's time/frequency synchronization
(including downlink AGC), and L1/L3 measurements, including
potential enhancement on SCell activation procedures if
necessary [RAN4, RAN2]
2. Specify enhancement on cell DTX/DRX mechanism including
the alignment of cell DTX/DRX and UE DRX in RRC_CONNECTED
mode, and inter-node information exchange on cell DTX/DRX
[RAN2, RAN1, RAN3]
Note: No change for SSB transmission due to cell DTX/DRX.
Note: The impact to IDLE/INACTIVE UEs due to the above
enhancement should be avoided.
3. Specify the following techniques in spatial and power
domains
Specify necessary enhancements on CSI and beam management
related procedures including measurement and report, and
signaling to enable efficient adaptation of spatial
elements (e.g. antenna ports, active transceiver chains)
[RAN1, RAN2]
Specify necessary enhancements on CSI related procedures
including measurement and report, and signaling to enable
efficient adaptation of power offset values between PDSCH
and CSI-RS [RAN1, RAN2]
Note: Above objectives are only for UE specific channels/
signals
Note: Legacy UE CSI/CSI-RS capabilities applies when
considering total number of CSI reports and requirements
4. Specify mechanism(s) to prevent legacy UEs camping on
cells adopting the Rel-18 NES techniques, if necessary
[RAN2]
5. Specify CHO procedure enhancement(s) in case source/
target cell is in NES mode [RAN2]
6. Specify inter-node beam activation and enhancements
on restricting paging in a limited area [RAN3].
7. Specify the corresponding RRM/RF core requirements,
if necessary, for the above features [RAN4]

In the context of transmission power control in shown in FIG. 5, there was a consensus to standardize procedures related to the CSI-RS and beam management, while minimizing the impact on the existing legacy UE.

Typically, UE beam management using the existing CSI-RS involves selecting a beam, transmitting the CSI-RS through that beam, providing UE feedback based on this CSI-RS, determining a beam based on this feedback, and performing transmission in the form corresponding to the determined beam. However, in this procedure, the UE only assumes the same beam used in the existing CSI-RS and is not informed of any changes in transmission power aimed at power reduction. That is, if there is a change in the transmission power for a specific beam, under the current standards, the UE remains uninformed of this alteration and cannot effectively assume that quality of the received signal.

One of objectives of the disclosure is to provide a method of a user equipment (UE) for successfully receiving information about a beam whose the transmission power changes in an NR transceiving environment, and obtaining power change information of a signal transmitted at a specific point in time based on the received information. In particular, the disclosure aims to provide a method of operating and managing a plurality of beams, whose transmission power changes, in the SSB or CSI-RS and configuring and/or managing correlation information for these beams.

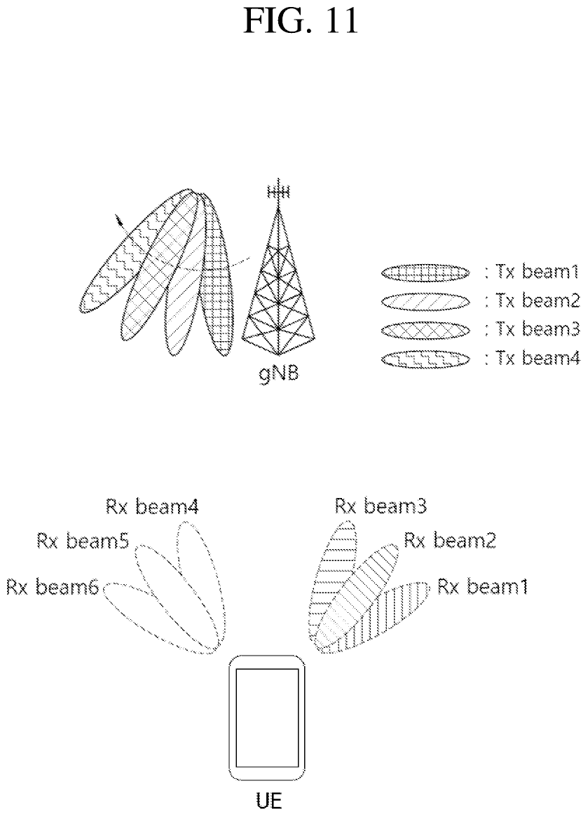

FIG. 11 is a diagram for describing a transmission power management scheme based on beams in accordance with embodiments of the disclosure.

Referring to FIG. 11, a UE may receive SSBs and/or CSI-RSs from a base station (gNB) by sweeping a plurality of reception beams (RX beam1 to Rx beam6). Here, the beam sweeping may refer to an operation that the base station and the UE sequentially or randomly sweep directional beams each having a predetermined pattern. As another example, the plurality of reception beams swept by the UE may include reception beams (RX beam1 to Rx beam3) corresponding to specific directionality.

The base station (gNB) may transmit SSBs and/or CSI-RSs to the UE multiple times by sweeping a plurality of transmission beams (e.g., Tx beam1 to Tx beam4). The UE may measure the SSBs and/or CSI-RSs respectively received through the plurality of reception beams. Specifically, the UE may calculate downlink channel states based on the received SSBs and/or CSI-RSs and determine a reception beam corresponding to the best state among the downlink channel states.

Hereinafter, the transmission power management scheme using the beam according to embodiments will be described.

The transmission power management scheme using the beam may be classified into (A) a transmission power management scheme using an SSB beam, and (B) a transmission power management scheme using a CSI-RS beam.

Additionally, this disclosure introduces (C) a power-controlled beam configuration scheme that employs a transmission configuration indicator (TCI).

The following sections will describe each of these schemes in detail.

### A. Transmission Power Management Scheme Using SSB Beam

In this transmission power management scheme, the beam used in the SSB is utilized for controlling transmission power. Typically, 4 to 8 SSB indices may be operated in FR1 based on subcarrier spacing in a single cycle while the UE performs scanning, and up to 64 SSB indices for different beams may be utilized in FR2. Some beams in this scenario may be operated as quasi co-location (QCL) by only altering the transmission power. For example, four beams that differ solely in the transmission power may effectively function as an omni-beam form. In these operating situations, the following specific schemes may be implemented to enable the UE to accurately obtain information on transmission power of actual transmission blocks.

### A-1. Scheme of Providing Beam Correlation Information Between SSB Indices

This scheme involves conveying correlation information between beam indices through an additional or independent radio resource control (RRC) message when transmitting information on an SSB beam index. For example, the base station may transmit information on quasi co-located (QCLed) beam groups and transmission power differences. This information may be transmitted explicitly as a QCLed index and a transmission power difference for each index, or implicitly as a sequence. For example, if the same QCL group {1, 3, 5, 7} is configured, it may be determined that each index has a transmission power of, for example, −3 dB relative to the previous index. The transmission power difference may vary based on the number of members in the group.

### A-2. Scheme of Transmitting Upper/Lower Beam Information

This scheme entails providing the UE with upper/lower beam information relative to the beam index referenced by the UE, particularly when the UE conducts a random access based on a specific SSB index. For example, if the UE references the SSB with an index of 3, the base station may provide the SSB index QCLed with that index, along with information about the power difference from the referenced index. In this case, only information on the indices having lower or higher transmission power than the referenced index may be transmitted. The transmission power difference may be either be standardized or conveyed implicitly, such as through the number of indices.

### B. Transmission Power Management Scheme Using CSI-RS Beam

In this transmission power management scheme, the beam associated with the CSI-RS is utilized for controlling transmission power. To this end, the correlation between multiple CSI-RSs may be transmitted in advance like the SSB described in the scheme A. However, unlike the SSB described in the scheme A, each CSI-RS is individually managed by an identity (ID), and correlation with other CSI-RSs having different IDs may be provided in advance. For example, the configuration ID of a CSI-RS QCLed with the current CSI-RS, and the transmission power difference from it, may be configured and/or provided. This may be applied to all RSs in the configuration information, except for the SSB, and specifically to those CSI-RSs that correspond to a certain position in a CSI-RS list or relate to the resource correlation. For example, power difference may not be applied when the time/frequency location is identical to the preceding CSI-RS. Alternatively, correlation information on each resource in the list within one CSI-RS resource configuration may be provided. For example, a QCL relationship or a transmission power offset value may be configured additionally for each CSI-RS in the list.

### C. Power-Controlled Beam Configuration Scheme Using Transmission Configuration Indicator (TCI)

In this scheme, the base station uses a transmission configuration indicator (TCI) field in downlink control information (DCI) to inform a UE that transmission is performed in a QCL manner with a specific CSI-RS after obtaining beam quality information through the CSI-RS. This field may be also used to inform the UE about any changes in transmission power.

### C-1. TCI Configuration Scheme Based on Power Correlation

This scheme involves configuring a TCI state by adding transmission power change to a QCL relationship with the referenced CSI-RS or SSB when configuring a TCI state value in the TCI-State. For example, there may be multiple TCI ID values, QCLed with a specific CSI-RS, which are different in a transmission power value for each TCI. Alternatively, mapping may be performed in the form of changing the transmission power by changing only specific position bits, and the mapping may also be defined in advance. For example, only 16 or 32 IDs may be configured when the TCI ID is configured in a control resource set (CORESET), and ½ of the most significant bit, which are not 0, is understood as QCLed with each ID corresponding to the most significant bit and changed in only the transmission power.

### C-2. Scheme of Applying Additional TCI Field to Transmit Power Correlation

This scheme utilizes an additional field to convey power change information when transmitting DCI including the TCI field. In this case, a power offset value may be predefined in the form of a table and used, or the predefined power offset value may be applied or ignored depending on the TCI configuration.

The forementioned schemes A, B and C may be combined with each other.

The schemes described in this disclosure may be implemented either independently or in a combined manner. Moreover, the terminology used in this disclosure is chosen for clarity and ease of understanding, and the disclosure remains applicable even if other terms with the same meanings are employed.

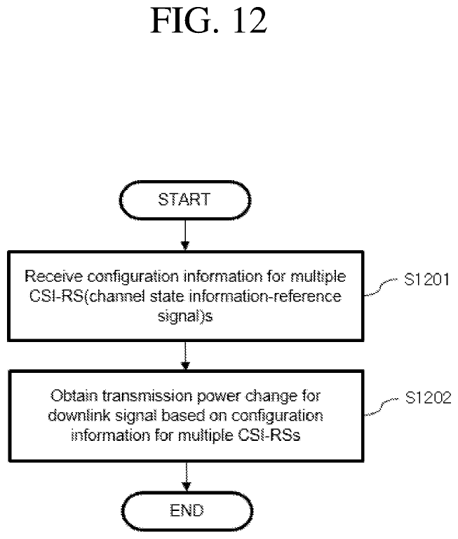

FIG. 12 is a flowchart illustrating an operation method of a UE according to an embodiment of the disclosure.

Referring to FIG. 12, the UE receives configuration information for a plurality of channel state information-reference signals (CSI-RS) from the base station (S1201). Then, the UE obtains transmission power change for a downlink signal based on the configuration information received from the base station (S1202). Here, the transmission power offset may be configured for each of the multiple CSI-RSs.

The configuration information may be single CSI-RS resource configuration information, and a quasi co-location (QCL) relationship may be configured for each CSI-RS. Here, each CSI-RS may be linked to an identity (ID) associated with its CSI-RS resource, and the transmission power offset may be configured based on the ID.

The foregoing transmission power offset may be an offset related to a physical downlink shared channel (PDSCH), for example, a CSI-RS transmission power offset for the PDSCH.

Meanwhile, the UE may receive at least one CSI-RS from the base station and perform CSI feedback based on the at least one received CSI-RS.

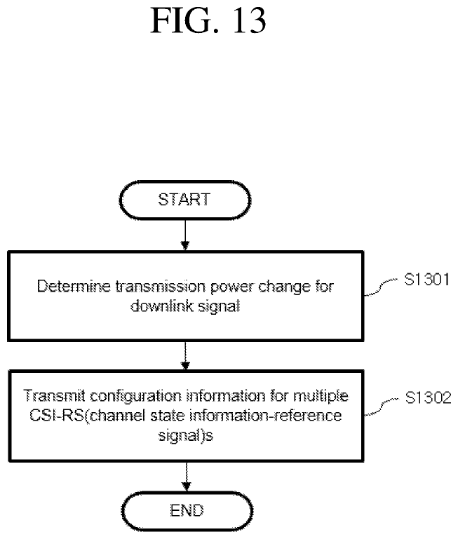

FIG. 13 is a flowchart illustrating an operation method of a base station according to an embodiment of the disclosure.

Referring to FIG. 13, the base station determines transmission power change for a downlink signal (S1301). Further, the base station transmits configuration information for a plurality of CSI-RSs to the UE after determining the transmission power change (S1202). Here, the transmission power offset may be configured for each of the plurality of CSI-RSs.

Meanwhile, the configuration information for the plurality of CSI-RSs may be single CSI-RS resource configuration information, and a quasi co-location (QCL) relationship may be configured for each of the plurality of CSI-RSs. Here, each CSI-RS may be linked to an identity (ID) associated with its CSI-RS resource, and the transmission power offset may be configured based on the ID.

The foregoing transmission power offset may be an offset related to a physical downlink shared channel (PDSCH), such as, a CSI-RS transmission power offset for the PDSCH.

Meanwhile, the base station may transmit at least one CSI-RS to the UE, and then receive CSI feedback from the UE.

Through the aforementioned operation method of the UE and/or the base station, the base station configures a correlation between each CSI-RS and its corresponding ID. This allows the UE to indirectly obtain channel state information (CSI) from other correlated CSI-RSs even though a specific CSI-RS is not actually received. For example, the UE may provide feedback on a CSI-RS that was not transmitted by the base station, or the UE may perform PDSCH reception by obtaining TCL information. Therefore, the UE may be notified about the control of the transmission power, even though the base station does not transmit the CSI-RS whose the transmission power has been reduced.

The embodiments described up to now may be implemented through various means. For example, the embodiments may be implemented by hardware, firmware, software, or a combination thereof. Details will be described with reference to the accompanying drawings.

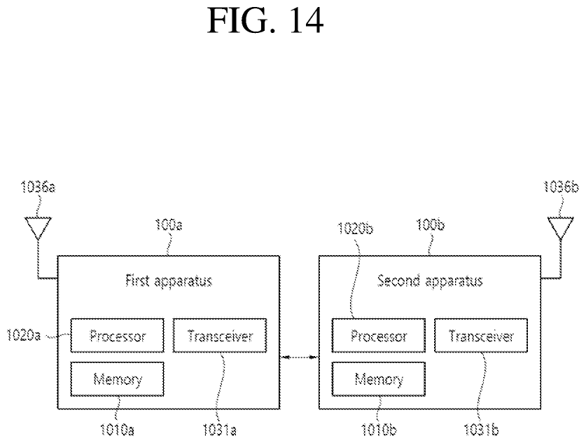

FIG. 14 is a diagram illustrating apparatuses according to an embodiment of the disclosure.

Referring to FIG. 14, a wireless communication system may include a first apparatus 100a and a second apparatus 100b.

The first apparatus 100a may include a base station, a network node, a transmission UE, a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The second apparatus 100b may include a base station, a network node, a transmission UE, a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The first apparatus 100a may include at least one processor, such as a processor 1020a, at least one memory, such as a memory 1010a, and at least one transceiver such as a transceiver 1031a. The processor 1020a may be tasked with executing the previously mentioned functions, procedures, and/or methods. The processor 1020a may be capable of implementing one or more protocols. For example, the processor 1020a may perform and manage one or more layers of a radio interface protocol. The memory 1010a may be connected to the processor 1020a and configured to store various types of information and/or instructions. The transceiver 1031a may be connected to the processor 1020a and controlled to transceive radio signals.

The second apparatus 100b may include at least one processor such as a processor 1020b, at least one memory device such as a memory 1010b, and at least one transceiver such as a transceiver 1031b. The processor 1020b may be tasked with executing the previously mentioned functions, procedures, and/or methods. The processor 1020b may be capable of implementing one or more protocols. For example, the processor 1020b may manage one or more layers of a radio interface protocol. The memory 1010b may be connected to the processor 1020b and configured to store various types of information and/or instructions. The transceiver 1031b may be connected to the processor 1020b and controlled to transceive radio signaling.

The memory 1010a and/or the memory 1010b may be respectively connected inside or outside the processor 1020a and/or the processor 1020b and connected to other processors through various technologies such as wired or wireless connection.

The first apparatus 100a and/or the second apparatus 100b may have one or more antennas. For example, an antenna 1036a and/or an antenna 1036b may be configured to transceive a radio signal.

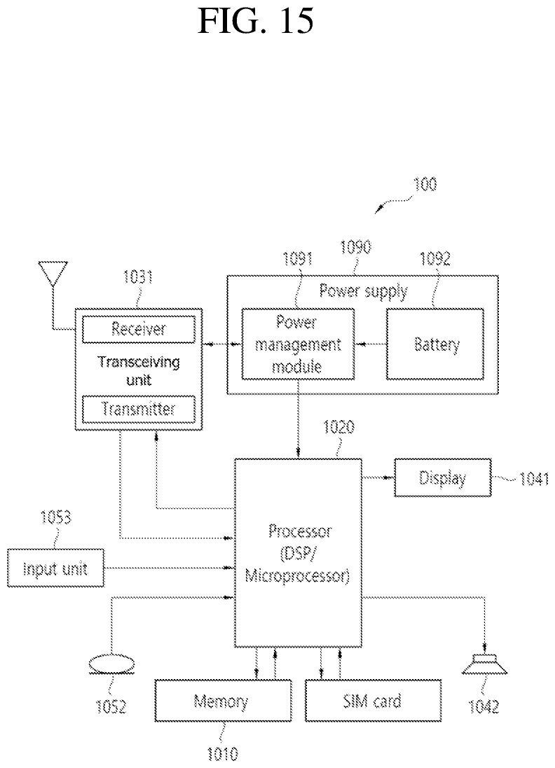

FIG. 15 is a block diagram showing a UE according to an embodiment of the disclosure.

In particular, FIG. 15 illustrates the previously described apparatus of FIG. 14 in more detail.

The apparatus includes a memory 1010, a processor 1020, a transceiving unit 1031 (e.g., transceiving circuit), a power management module 1091 (e.g., power management circuit), a battery 1092, a display 1041, an input unit 1053 (e.g., input circuit), a loudspeaker 1042, a microphone 1052, a subscriber identification module (SIM) card, and one or more antennas.

The processor 1020 may be configured to implement the proposed functions, procedures, and/or methods described in the disclosure. The layers of the radio interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modulator and demodulator (MODEM). For example, the processor 1020 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel®, KIRIN™ series of processors made by HiSilicon®, or the corresponding next-generation processors.

The power management module 1091 manages a power for the processor 1020 and/or the transceiver 1031. The battery 1092 supplies power to the power management module 1091. The display 1041 outputs the result processed by the processor 1020. The input unit 1053 may be an individual circuit that receives an input from a user or other devices and convey the received input with associated information to the processor 1020. However, the embodiments are not limited thereto. For example, the input unit 1053 may be implemented as at least one of touch keys or buttons to be displayed on the display 1041 when the display 1041 is capable of sensing touches, generating related signals according to the sensed touches, and transferring the signals to the processor 1020. The SIM card is an integrated circuit used to securely store international mobile subscriber identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include read-only memory (ROM), random access memory (RAM), flash memory, a memory card, a storage medium, and/or other storage device. The embodiments described in the disclosure may be implemented as software program or application. In this case, such software program or application may be stored in the memory 1010. In response to a predetermined event, the software program or application stored in the memory 1010 may be fetched and executed by the processor 1020 for performing the function and the method described in this disclosure. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020, receives, and transmits a radio signal under the control of the processor 1020. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives audio input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 for a user's recognition or for convenience.

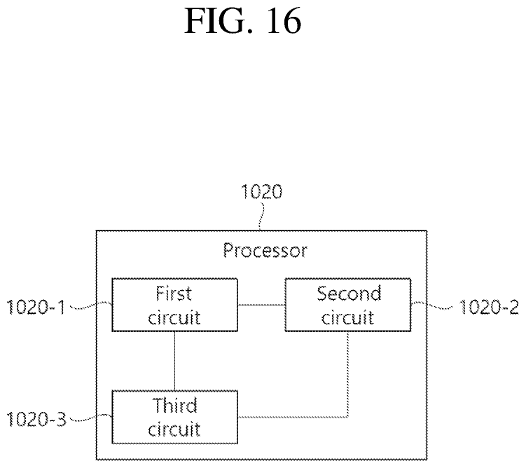

FIG. 16 is a block diagram illustrating a processor in accordance with an embodiment.

Referring to FIG. 16, a processor 1020 in which the disclosure of the present specification is implemented may include a plurality of circuitry to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP) and may include at least one of a digital signal processor (DSP), a central processing unit (CPU), and a graphics processing unit (GPU).

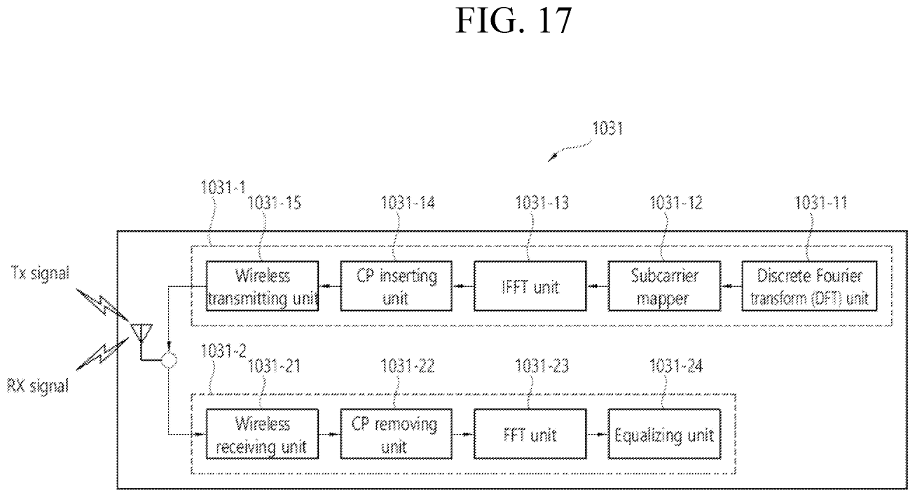

FIG. 17 is a detailed block diagram of a transceiver of a first apparatus shown in FIG. 14 or a transceiving unit of an apparatus shown in FIG. 15.

Referring to FIG. 17, the transceiving unit 1031 (e.g., transceiving circuit) includes a transmitter 1031-1 and a receiver 1031-2. The transmitter 1031-1 includes a discrete Fourier transform (DFT) unit 1031-11 (e.g., DFT circuit), a subcarrier mapper (e.g., subcarrier mapping circuit) 1031-12, an IFFT unit 1031-13 (e.g., IFFT circuit), a cyclic prefix (CP) insertion unit 1031-14 (e.g., CP insertion circuit), and a wireless transmitting unit 1031-15 (e.g., wireless transmitting circuit). The transmitter 1031-1 may further include a modulator. Further, the transmitter 1031-1 may for example include a scramble unit (not shown), a modulation mapper (not shown), a layer mapper (not shown), and a layer permutator (not shown), which may be disposed before the DFT unit 1031-11. That is, to prevent a peak-to-average power ratio (PAPR) from increasing, the transmitter 1031-1 subjects information to the DFT unit 1031-11 before mapping a signal to a subcarrier. The signal spread (or pre-coded) by the DFT unit 1031-11 is mapped onto a subcarrier by the subcarrier mapper 1031-12 and made into a signal on the time axis through the IFFT unit 1031-13.

The DFT unit 1031-11 performs DFT on input symbols to output complex-valued symbols. For example, when Ntx symbols are input (here, Ntx is a natural number), DFT has a size of Ntx. The DFT unit 1031-11 may be referred to as a transform precoder. The subcarrier mapper 1031-12 maps the complex-valued symbols onto respective subcarriers in the frequency domain. The complex-valued symbols may be mapped onto resource elements corresponding to resource blocks allocated for data transmission. The subcarrier mapper 1031-12 may be referred to as a resource element mapper. The IFFT unit 1031-13 performs IFFT on the input symbols to output a baseband signal for data as a signal in the time domain. The CP inserting unit 1031-14 copies latter part of the baseband signal for data and inserts the latter part in front of the baseband signal for data. CP insertion prevents inter-symbol interference (ISI) and inter-carrier interference (ICI), thereby maintaining orthogonality even in a multipath channel.

On the other hand, the receiver 1031-2 includes a wireless receiving unit 1031-21 (e.g., wireless receiving circuit), a CP removing unit 1031-22 (e.g., CP removing circuit), an FFT unit 1031-23 (e.g., FFT circuit), and an equalizing unit 1031-24 (e.g., equalizing circuit). The wireless receiving unit 1031-21, the CP removing unit 1031-22, and the FFT unit 1031-23 of the receiver 1031-2 perform reverse functions of the wireless transmitting unit 1031-15, the CP inserting unit 1031-14, and the IFFT unit 1031-13 of the transmitter 1031-1. The receiver 1031-2 may further include a demodulator.

According to the embodiments of the disclosure, when network power reduction technology is applied to a wireless communication system, the UE may track a successful transmission power change and efficiently decode a downlink signal based on the transmission power change.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

What is claimed is:

1. A method of operating a user equipment (UE) in a wireless communication system, the method comprising:
receiving configuration information for a plurality of channel state information-reference signals (CSI-RS); and
obtaining a transmission power change for a downlink signal, based on the received configuration information,
wherein a transmission power offset is configured for each of the plurality of CSI-RSs.

2. The method of claim 1, wherein the received configuration information is single CSI-RS resource configuration information.

3. The method of claim 1, wherein a quasi co-location (QCL) relationship is configured for each of the plurality of CSI-RSs.

4. The method of claim 1, wherein each of the plurality of CSI-RSs is linked to an identity (ID) associated with a corresponding CSI-RS resource, and the transmission power offset is configured based on the ID.

5. The method of claim 1, further comprising:
receiving at least one CSI-RS; and
performing CSI feedback based on the at least one received CSI-RS.

6. The method of claim 1, wherein the configuration information for the plurality of CSI-RSs is received through a radio resource control (RRC) message.

7. A method of operating a base station in a wireless communication system, the method comprising:
determining a transmission power change for a downlink signal; and
transmitting configuration information for a plurality of channel state information-reference signals (CSI-RS) after determining the transmission power change,
wherein a transmission power offset is configured for each of the plurality of CSI-RSs.

8. The method of claim 7, wherein the configuration information for the plurality of CSI-RSs is single CSI-RS resource configuration information.

9. The method of claim 7, wherein a quasi co-location (QCL) relationship is configured for each of the plurality of CSI-RSs.

10. The method of claim 7, wherein each of the plurality of CSI-RSs is linked to an identity (ID) associated with a corresponding CSI-RS resource, and the transmission power offset is configured based on the ID.

11. The method of claim 7, further comprising:
transmitting at least one CSI-RS; and
receiving CSI feedback after transmitting the at least one CSI-RS.

12. The method of claim 7, wherein the configuration information for the plurality of CSI-RSs is transmitted through a radio resource control (RRC) message.

13. A communication apparatus in a wireless communication system, the apparatus comprising:
at least one processor; and
at least one memory configured to store instructions and be operably electrically connectable to the at least one processor,
wherein the at least one processor is configured to execute the instructions stored in the at least one memory for performing operations of:
receiving configuration information for a plurality of channel state information-reference signals (CSI-RS); and
obtaining a transmission power change for a downlink signal, based on the configuration information for the plurality of CSI-RSs,
wherein a transmission power offset is configured for each of the plurality of CSI-RSs.

14. The apparatus of claim 13, wherein the received configuration information for the plurality of CSI-RSs is single CSI-RS resource configuration information.

15. The apparatus of claim 13, wherein a quasi co-location (QCL) relationship is configured for each of the plurality of CSI-RSs.

16. The apparatus of claim 13, wherein each of the plurality of CSI-RSs is linked to an identity (ID) associated with a corresponding CSI-RS resource, and the transmission power offset is configured based on the ID.

17. The apparatus of claim 13, wherein the operation further comprises:
receiving at least one CSI-RS; and
performing CSI feedback based on the at least one received CSI-RS.

18. The apparatus of claim 13, wherein the configuration information for the plurality of CSI-RSs is received through a radio resource control (RRC) message.
